(19) United States
(12) Patent Application Publication
(10) Pub. No.: US 2008/0256509 A1
(43) Pub. Date: Oct. 16, 2008

(54) Pattern-based programming system for automatic code generation

(75) Inventor: Daniele Mazzeranghi, Prato (IT)

Correspondence Address: Daniele Mazzeranghi, Via Zucca 7, Prato, 59100, omitted

(73) Assignee: Daniele Mazzeranghi, Prato (IT)

(21) Appl. No.: 12/038,741

(22) Filed: Feb. 27, 2008

Related U.S. Application Data
(60) Provisional application No. 60/911,208, filed on Apr. 11, 2007.

(51) Int. Cl. G06F 9/44

(52) U.S. Cl. 717/106

(57) ABSTRACT

This invention relates to a pattern-based programming system for automatic generation of high-level programming language code. Many code generation systems have been developed that are able to generate source code by means of templates, which are defined by means of transformation languages such as XSL, ASP, etc. But these templates cannot be easily combined because they map parameters and code snippets provided by the programmer directly to the target programming language. On the contrary, the patterns used in this programming system generate a code model that can be used as input to other patterns, thereby providing an unlimited capability of composition. Since such a composition may be split across different files or code units, a high degree of separation of concerns can be achieved.

A pattern itself can be created by using other patterns, thus making it easy to develop new patterns. It is also possible to implement an entire programming paradigm, methodology or framework by means of a pattern library: design patterns, Design by Contract, Aspect Oriented Programming, multi-dimensional separation of concerns, data access layer, user interface framework, class templates, etc. This way, developing a new programming paradigm does not require to extend an existing programming system (compiler, runtime support, etc.), thereby focusing on the paradigm concepts.

This programming system introduces a higher abstraction level with respect to traditional programming languages: the basic elements of a program are no longer classes and methods but, for instance, design patterns and crosscutting concerns.

### 1 TECHNICAL FIELD OF THE INVENTION

This invention relates generally to computer programming systems, and more particularly to a pattern-based programming system for automatic code generation.

### 2 BACKGROUND OF THE INVENTION

Software programming based on traditional programming languages (such as C, C++, Lisp, Prolog, Java, C#, etc.) is graphically represented in FIG. 1 (where the C# programming language has been used). Such languages differ under several aspects:
Abstraction level from the underlying hardware or operating system.
Support for paradigms and methodologies.
Extensive core libraries.

However, the size of equivalent real programs is not very different from language to language. In other words, traditional programming languages are not able to automate common repetitive programming tasks.

Many code generation systems have been developed that are able to generate source code by applying code templates, which are defined by means of transformation languages such as XSL, ASP, etc. This new programming model is sketched in FIG. 2 (where the target programming language is C#).

Such code generation systems are able to generate very sophisticated code snippets, including complete programs, in a variety of programming languages. Nevertheless, these code templates cannot be easily combined because they map parameters and code snippets provided by the programmer directly to the target programming language. In order to modify or extend the generated code, the programmer may edit either the template code or directly the generated code.

The former approach may require a deep understanding of the template structure; furthermore, the template source code could not be available. The latter option is suitable for small changes since the transformation engine cannot be exploited; furthermore, such changes have to be repeated if the template is applied again, due to changes in the template parameters or in the template code itself. However, some of the code generation systems are able to keep certain kinds of manual changes to the generated code when the template is applied afterwards.

Moreover, template code itself could benefit by the transformation engine, but code generation systems do not usually provide support for meta-templates which generate code templates.

### 3 SUMMARY OF THE INVENTION

This invention relates to a pattern-based programming system, known as Panda (Pattern Network Development Assistant), for automatic generation of high-level programming language code. This system attempts to inherit the capability to automate repetitive programming tasks from traditional code generation systems together with the expressive power of programming languages.

A Panda pattern may be classified as functional or procedural. A functional pattern generates an instance of a code model that can be used as input to another functional pattern or may be modified by a procedural pattern, thereby providing an unlimited capability of composition (see FIG. 3). Since such a composition may be split across different files or code units, a high degree of separation of concerns can be achieved.

A pattern itself can be created by using other patterns, thus making it easy to develop new patterns. Moreover, an entire programming paradigm, methodology or framework can be easily implemented by developing a small library of patterns: design patterns, Design by Contract, Aspect-Oriented Programming, multidimensional separation of concerns, data access layer, user interface framework, class templates, etc. As a consequence, Panda makes it possible to focus on the paradigm concepts instead of the implementation details. Furthermore, several paradigms may be used at the same time by simply joining the corresponding pattern libraries.

### 4 BRIEF DESCRIPTION OF THE DRAWINGS

FIG. 1 is a diagram illustrating the manual coding process in the current art (where the programming language is C#).

FIG. 2 is a diagram illustrating the automatic code generation process in the current art (where the target programming language is C#).

FIG. 3 is a diagram illustrating the automatic code generation process in the Panda programming system described in the present invention (where the target programming language is C#).

FIGS. 4a, 4b and 4c show the grammar of the Panda programming language.

FIG. 5 contains a simple example of a Panda program.

FIG. 6 shows the C# code generated from the Panda program shown in FIG. 5.

FIG. 7 contains a simple example of RTS-based pattern definition.

FIG. 8 contains a simple example of language-based pattern definition.

FIGS. 9a, 9b, 9c, 9d and 9e contain a more complex example of language-based pattern definition.

FIG. 10 contains an example of usage of the Panda pattern defined in FIGS. 9a, 9b, 9c, 9d and 9e.

FIGS. 11a and 11b show the C# code generated from the Panda program shown in FIG. 10.

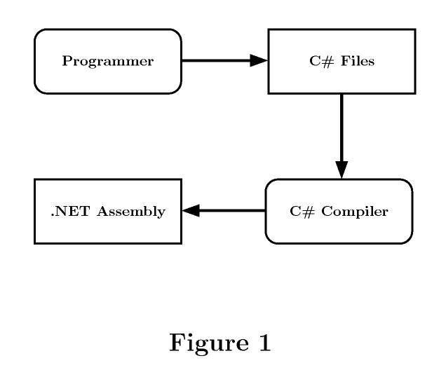

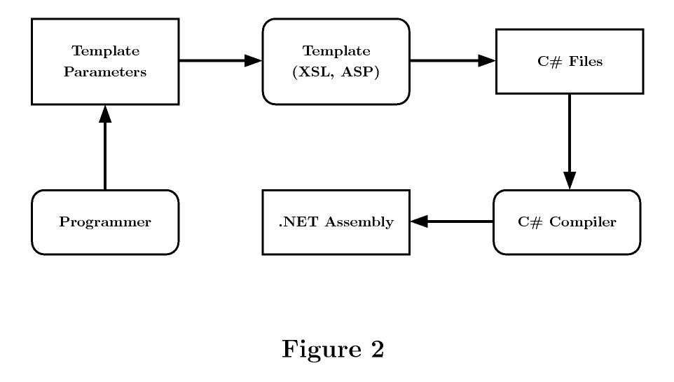

### 5 DETAILED DESCRIPTION OF THE INVENTION

The Panda programming system executes Panda programs by means of a runtime support (RTS), implemented in a given programming language or framework (RTSL). The RTS is responsible for connecting the elements of a Panda program, that are listed in the following:
A set of RTS-based patterns, each of which is defined by a class implemented in the RTSL.
A set of language-based patterns, each of which is defined by a Panda statement (where, in turn, both RTS-based and language-based patterns can be used).
A sequence of Panda statements which are executed by the RTS by calling the referenced patterns; the result of this execution is a set of RTSL objects which represent the code to be generated.
A code processor which generates the target code by processing the RTSL objects created by the RTS.

.NET and Java are examples of RTSL.

Some examples of patterns are listed in the following:
Patterns for creating and modifying code elements (such as classes and methods) of an object-oriented language (such as, for instance, C#, Visual Basic .NET, Java, etc.).
Patterns for creating and modifying SQL Server scripts.
Design by Contract patterns.
Patterns for applying design patterns.
Patterns for generating a Windows user interface (by creating, for instance, C# Windows Forms).
Patterns for generating a Web user interface (by creating, for instance, ASP.NET pages).
Patterns for generating a data access layer (by using, for instance, the ADO.NET framework).
Aspect-Oriented Programming patterns.
Patterns for implementing subject-oriented programming and multi-dimensional separation of concerns.

Some examples of code represented by RTSL objects follow:
C#, Visual Basic .NET, etc.
ASP.NET.
Java.
SQL Server script.

Some examples of code processors are listed in the following:
Generator of .NET source files (C#, Visual Basic .NET, etc.).
Generator of Visual Studio .NET solutions.
Generator of .NET assemblies (both libraries and applications).
Generator of Java source files.
Generator of SQL Server script files.

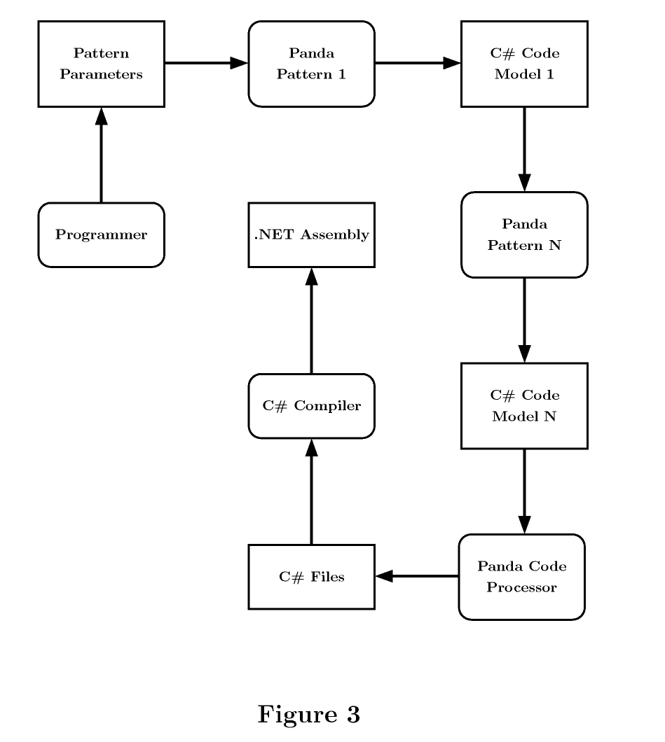

FIG. 3 illustrates an example of execution of a Panda program where the following elements are involved:
.NET RTSL.
C# RTSL objects.
Generator of .NET assemblies.

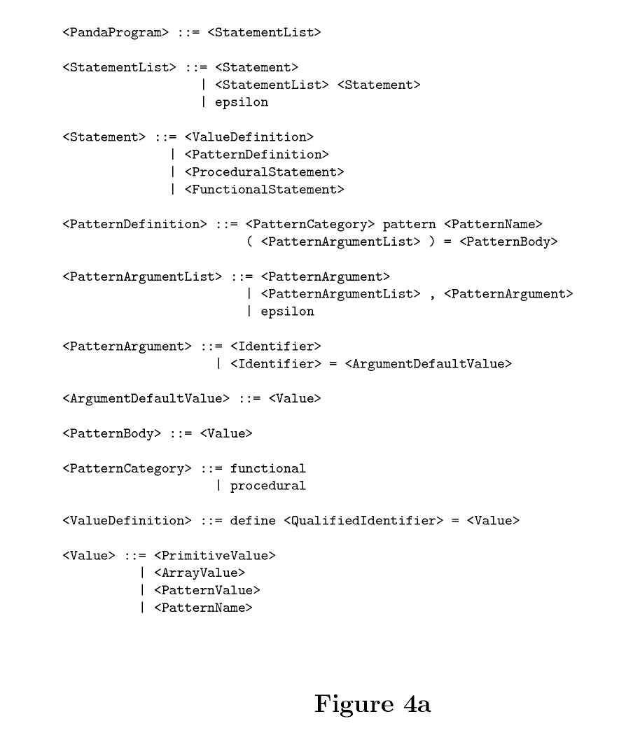

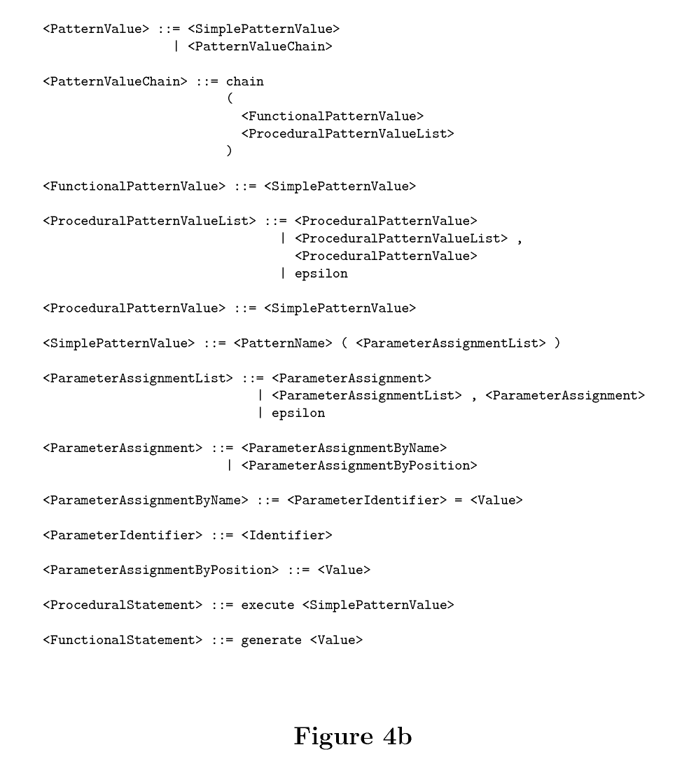

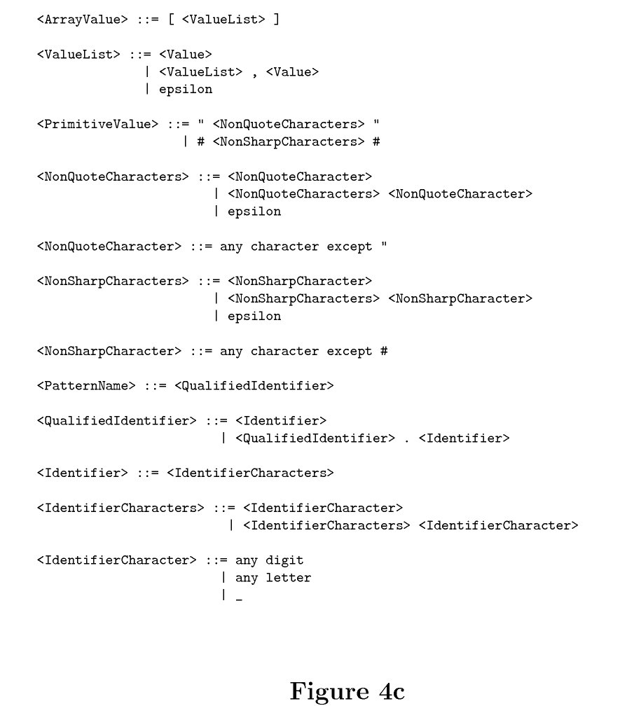

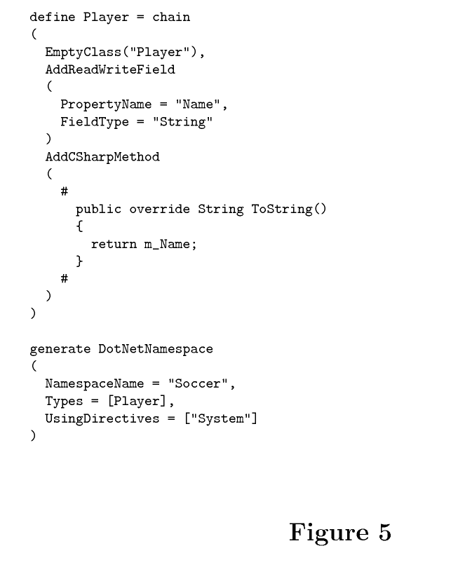

FIGS. 4a, 4b and 4c show the grammar of the Panda programming language. A Panda program is made up of a sequence of Panda statements. A <FunctionalStatement> is used to generate a Panda value, which represents an RTSL object. The generated value is specified by the patterns used inside the <FunctionalStatement>. An example is shown in FIG. 5, where a C# namespace containing the Player class is generated (see the generate keyword) by means of the DotNetNamespace pattern. This is a case of a <SimplePatternValue> expression, where only one pattern is specified together with its parameters. Values can also be specified by composing two or more patterns in a <PatternValueChain> expression, which contains the chain keyword followed by a <FunctionalPatternValue> expression and a list of <ProceduralPatternValue> expressions. An example is shown in FIG. 5, where the Player class is defined by means of three patterns:
the EmptyClass pattern (which generates an empty C# class given its name),
the AddReadWriteField pattern (which adds a C# field together with a get/set property, given its name and type),
the AddCSharpMethod pattern (which adds a C# method given its C# source code).

Pattern parameters can be specified by name or by position (see the <ParameterAssignmentByName> and <ParameterAssignmentByPosition> expressions). For example, in FIG. 5, the PropertyName and FieldType parameters of the AddReadWriteField pattern are assigned by specifying the parameter name. On the contrary, the ClassName parameter of the EmptyClass pattern is assigned by position (as a matter of fact, ClassName is omitted); this corresponds to the typical behaviour of traditional programming languages (such as, for instance, C/C++, Java, etc.).

Primitive values are specified by using a delimiter character, either the quote character (“) or the sharp character (#) (escape sequences are not yet supported). A primitive value can be used to represent strings, numbers, source code in another programming language, etc. For example, in FIG. 5, the quote character is used for specifying the Player class name, whereas the sharp character is used for importing the C# code of the ToString method.

The square brackets are used for specifying list of values. As shown in FIG. 5, the DotNetNamespace pattern accepts, in the Types parameter, a list of types to be enclosed in a .NET namespace.

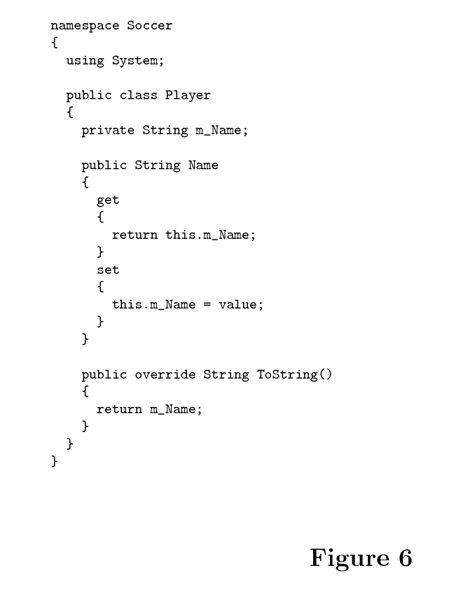

The <ValueDefinition> expression is used to associate an identifier to a Panda value, in order to increase the modularity of a Panda program (see FIG. 5, where the Player identifier is associated to the Player class by using the define keyword). By using a code processor which generates C# code, the output of the Panda program listed in FIG. 5 is shown in FIG. 6.

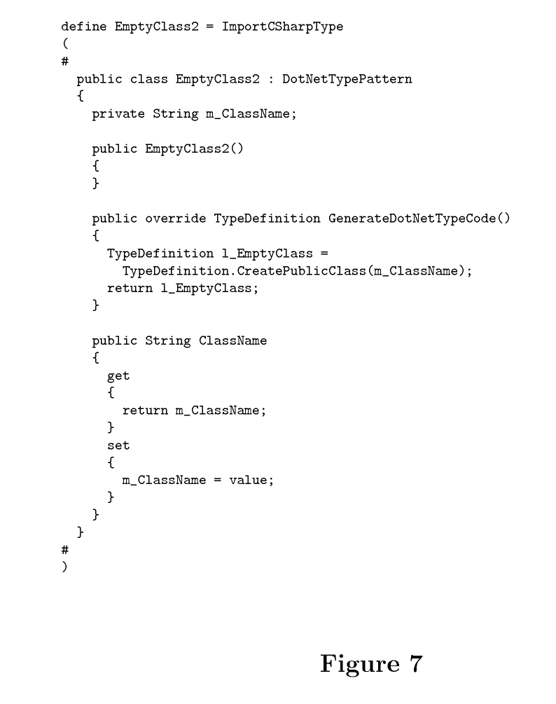

RTS-based patterns are mainly used for simple basic patterns (such as, for instance, the AddReadWriteField pattern) and performance-critical patterns (such as, for instance, the AddCSharpMethod pattern). An RTS-based pattern may be defined by using a generic software development tool able to generate a module compatible with the RTSL. Another option is to write a Panda program and use a code processor which generates modules compatible with the RTSL (in this case, Panda makes it possible to create new patterns by means of previously created patterns). FIG. 7 contains the definition of a pattern equivalent to the EmptyClass pattern, where the DotNetTypePattern abstract base class has been used, which is the base class of the patterns that generate a .NET class. The definition of the EmptyClass2 pattern makes use of the TypeDefinition class, which represents a .NET class or struct. TypeDefinition belongs to the DotNetCode namespace, which implements a complete .NET code model, particularly suited for the C# language.

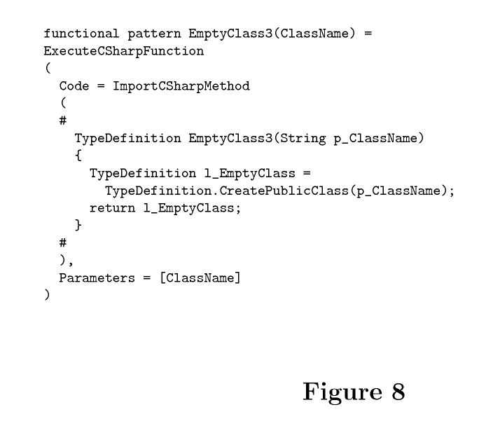

Language-based patterns are mainly used for large pattern libraries (such as, for instance, a pattern library for generating a Web user interface), since they are more intuitive with respect to RTS-based patterns. A pattern equivalent to the EmptyClass and EmptyClass2 patterns is defined in FIG. 8, where the functional pattern statement has been used. The definition of the EmptyClass3 pattern makes use of the ExecuteCSharpFunction pattern, which compiles and executes the C# method specified in the Code parameter (the method's parameters are provided by means of the Parameters parameter). The object returned by the method (a TypeDefinition object in this case) is, in turn, returned by the ExecuteCSharpFunction pattern and, afterwards, by the EmptyClass3 pattern. Therefore, the ExecuteCSharpFunction pattern makes it possible to achieve the same expressive power of RTS-based patterns without requiring a C# IDE, at the price of a worse performance. Moreover, also in this case, Panda makes it possible to create new patterns by means of previously created patterns.

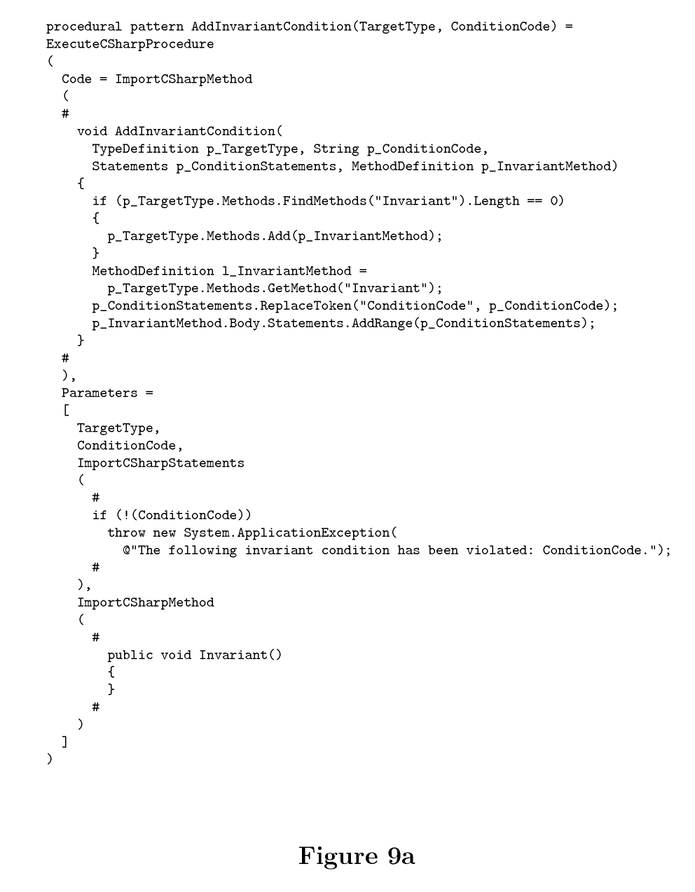

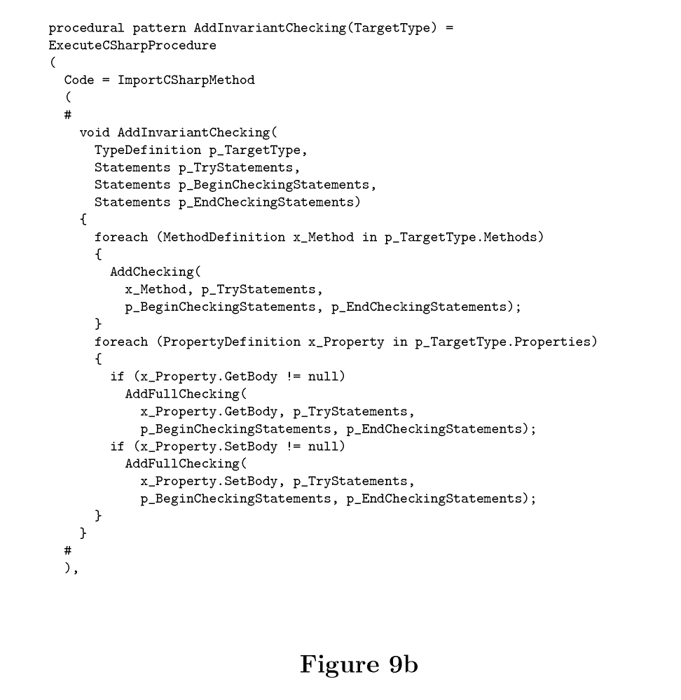

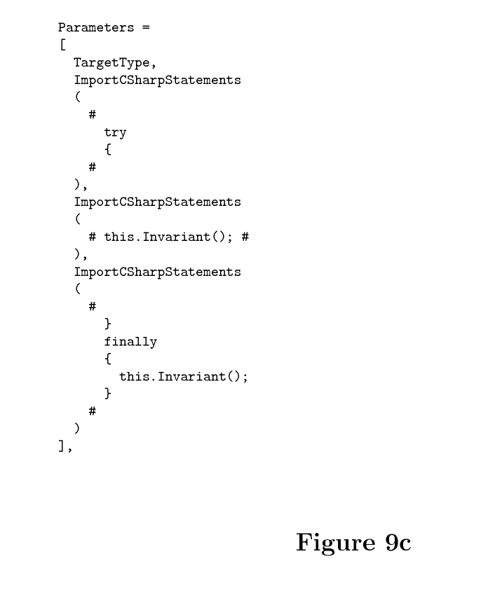

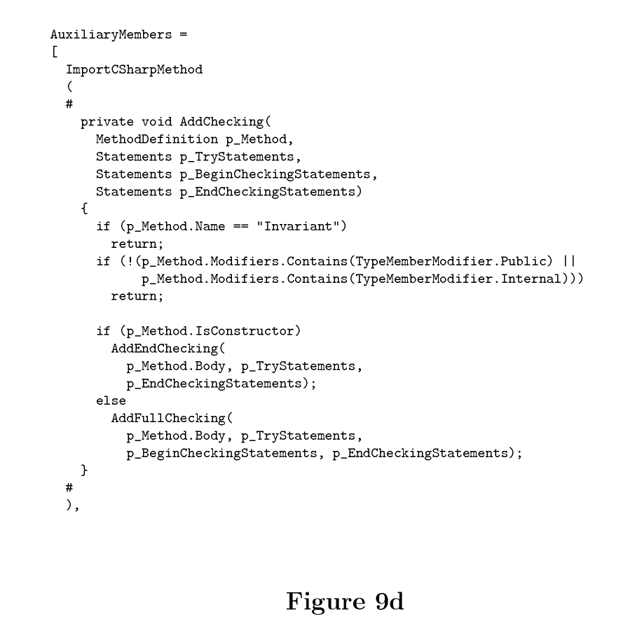

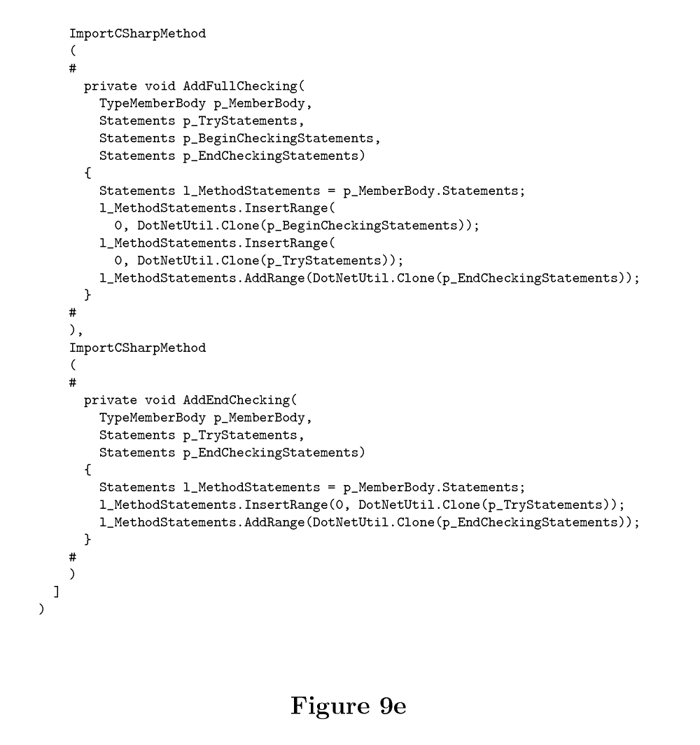

A more complex pattern definition for adding invariant checking (which is one of the elements of the Design by Contract methodology) is shown in FIGS. 9a, 9b, 9c, 9d and 9e. Actually, two patterns are defined:
AddInvariantCondition, for specifying a constraint on the fields of a class inside a method conventionally named Invariant,
AddInvariantChecking, for checking the specified constraints before and after executing any public or internal method or property.

The ExecuteCSharpProcedure pattern has been used, that differs from the ExecuteCSharpFunction pattern only in the void return value; furthermore, the AuxiliaryMembers parameter has been used to split the pattern code into four methods and the DotNetUtil.Clone method has been used to create separate checking statements for each method and property.

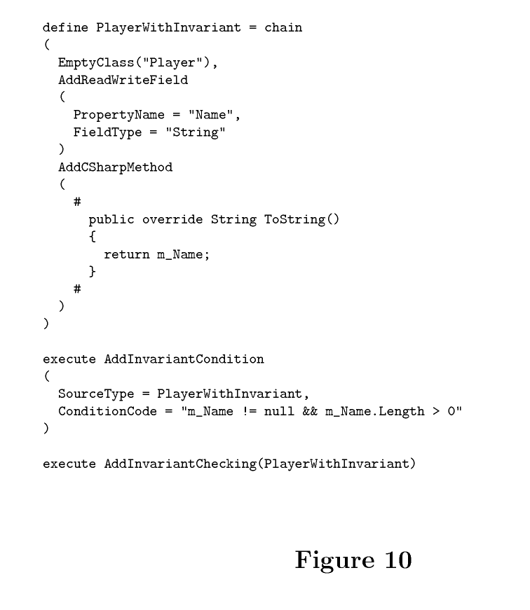

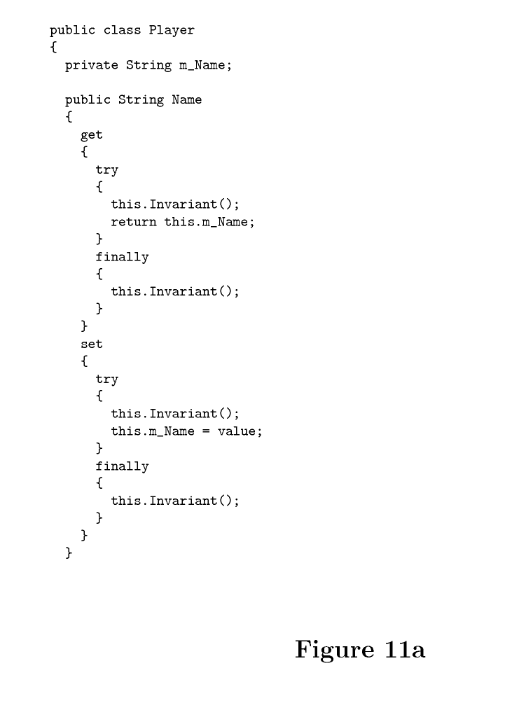

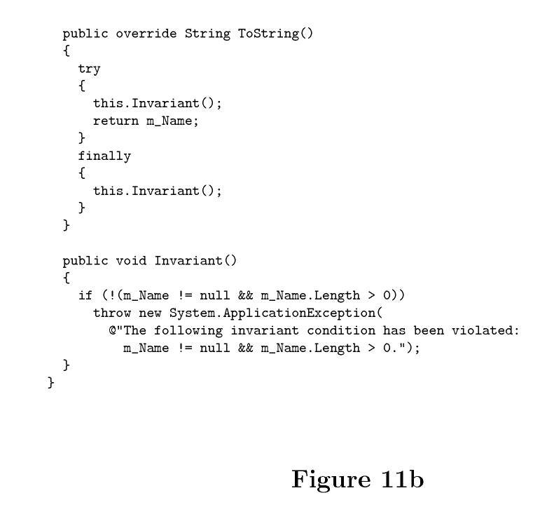

These two Design by Contract patterns can be used to check the content of the m_Name field of the Player class (see FIG. 10), thus generating the C# code shown in FIGS. 11a and 11b. It is worth noting that these patterns are not used in the pattern chain which defines the PlayerWithInvariant identifier, but in two separate procedural statements (see the execute keyword), in order to achieve separation of concerns.

### REFERENCES

[1] ALLISON D. S. (2006). Method and apparatus for deriving functions from other functions in a programming language. U.S. Pat. No. 7,146,601 (717/114), United States Patent and Trademark Office.
[2] BERGER K. A., TURNER L. J., WILCOX A. E. (2007). System and method for generating user interface code. U.S. Pat. No. 7,243,334 (717/109), United States Patent and Trademark Office.
[3] BRASSARD M. (2004). Component-based source code generator. U.S. Pat. No. 6,742,175 (717/107), United States Patent and Trademark Office.
[4] BURD G. S., COOPER K. B., GUTHRIE S. D., EBBO D. S., ANDERS M. T., PETERS T. A. (2006). Server-side code generation from a dynamic web page content file. U.S. Pat. No. 6,990,653 (717/108), United States Patent and Trademark Office.
[5] CORBIN L. S., PORKKA J. A. (2003). Method and system for representing a high-level programming language data structure in a mark-up language. U.S. Pat. No. 6,594,823 (717/143), United States Patent and Trademark Office.
[6] EBBO D. S., GUTHRIE S. D. (2006). User control objects for providing server-side code generation from a user-defined dynamic web page content file. U.S. Pat. No. 7,120,897 (717/108), United States Patent and Trademark Office.
[7] ECMA (2006). Standard ECMA-334. C# Language Specification (4^{th} Edition). Ecma International. http://www.ecma-international.org/publications/standards/Ecma-334.htm.
[8] FOWLOW B. G., NUYENS G. B., MULLER H. E. (1999). Code generator for applications in distributed object systems. U.S. Pat. No. 5,860,004 (717/109), United States Patent and Trademark Office.
[9] GAMMA E., HELM R., JOHNSON R., VLISSIDES J. (1995). Design Patterns: Elements of Reusable Object-Oriented Software. Addison-Wesley.
[10] HARRISON W., OSSHER H. (1993). “Subject-Oriented Programming (A Critique of Pure Objects)”. OOPSLA '93: Proceedings of the eighth annual conference on Object-oriented programming systems, languages, and applications, 411-428.
[11] HEUGHEBAERT A., CEULAER L. D. (2002). Method and apparatus for multi-language software code generation. U.S. Pat. No. 6,408,431 (717/106), United States Patent and Trademark Office.
[12] KAUFFMAN S. V. (2005). Code generator system for digital libraries. U.S. Pat. No. 6,915,303 (707/102), United States Patent and Trademark Office.
[13] KICZALES G., LAMPING J., MENHDHEKAR A., MAEDA C., LOPES C., LOINGTIER J. M., IRWIN J. (1997). “Aspect-Oriented Programming”. In Proceedings of the European Conference on Object-Oriented Programming, volume 1241, 220-242. Springer-Verlag.
[14] LIN N. H. (2005). Self-generating automatic code generator. U.S. Pat. No. 6,876,314 (341/50), United States Patent and Trademark Office.
[15] LINDSEY A. H. (2005). System and method for generating target language code utilizing an object oriented code generator. U.S. Pat. No. 6,877,155 (717/108), United States Patent and Trademark Office.
[16] LITTLE T., KONKUS L., LAVALOU G., METSAPORTTI T. (2005). System and method for computer code generation. U.S. Pat. No. 6,973,640 (717/106), United States Patent and Trademark Office.
[17] MARMELSTEIN R. E. (1993). Graphics system for automatic computer code generation. U.S. Pat. No. 5,187,788 (717/109), United States Patent and Trademark Office.
[18] MEYER B. (1997). Object-Oriented Software Construction (2nd Edition). Prentice-Hall.
[19] PARNAS D. L. (1972). “On the Criteria To Be Used in Decomposing Systems into Modules”. Communications of the ACM, 15(12):1053-1058.
[20] POLAK W. H. (2007). Methods and systems for automatically generating provably correct computer program code. U.S. Pat. No. 7,243,086 (706/13), United States Patent and Trademark Office.
[21] PRESTON K. R., LEATHEM C. A. (2007). Apparatus for automatically generating source code. U.S. Pat. No. 7,197,739 (717/106), United States Patent and Trademark Office.
[22] REYNA D., DZENG S. L. (2007). System and method for common code generation. U.S. Pat. No. 7,162,709 (717/104), United States Patent and Trademark Office.
[23] SADIQ W. (2007). System and method for automated code generation using language neutral software code. U.S. Pat. No. 7,263,686 (717/110), United States Patent and Trademark Office.
[24] SADIQ W., CUMMINS F. A. (1999). Object-oriented code generation system and method. U.S. Pat. No. 5,978,581 (717/104), United States Patent and Trademark Office.
[25] SAVAGE W. H., COWAN W. F., GEIGER JR. R. J., LEMAN G. D. (2003). Automated software code generation from a metadata-based repository. U.S. Pat. No. 6,604,110 (707/102), United States Patent and Trademark Office.
[26] SCHLOEGEL K. A., OGLESBY D. V., ENGSTROM E., BHATT D. (2007). Model-based composable code generation. U.S. Pat. No. 7,219,328 (717/104), United States Patent and Trademark Office.
[27] SOLTON R. T., TABB L. (1999). Development system with methods for bi-directional application program code generation. U.S. Pat. No. 5,911,070 (717/105), United States Patent and Trademark Office.
[28] STROUSTRUP B. (1997). The C++Programming Language (3rd Edition). Addison-Wesley.
[29] TARR P., OSSHER H., HARRISON W., SUTTON S. M. (1999). “N Degrees of Separation: Multi-Dimensional Separation of Concerns”. In ICSE '99: Proceedings of the 21st international conference on Software engineering, 107-119. IEEE Computer Society Press.
[30] ZORC S. (2007). Method and system for automatically generating source code based on a mark-up language message definition. U.S. Pat. No. 7,249,345 (717/106), United States Patent and Trademark Office.

What is claimed is:

1. A programming system for automatic generation of high-level programming language code comprising a pattern-based programming language and a runtime support.

2. The programming system of claim 1 wherein said patterns make it possible to automate repetitive programming tasks.

3. The programming system of claim 2 wherein said patterns generate a code model that may be used as input to other patterns, in order to provide unlimited pattern composition.

4. The programming system of claim 3 wherein said pattern composition may be easily achieved by using the chain statement.

5. The programming system of claim 4 wherein said pattern composition may be split across different files or code units, in order to achieve separation of concerns.

6. The programming system of claim 5 wherein said patterns can be created by using other patterns.

7. The programming system of claim 6 wherein a program is defined by a set of said patterns, a sequence of statements in said pattern-based programming language, a code processor for processing said code model.

8. The programming system of claim 7 wherein said programs can be executed by means of said runtime support.
